(19) United States
(12) Patent Application Publication
(10) Pub. No.: US 2018/0058581 A1
(43) Pub. Date: Mar. 1, 2018

(54) SEAL ARRANGEMENT FOR AN ACTUATOR

(71) Applicant: Goodrich Actuation Systems SAS, Buc (FR)

(72) Inventors: Arnauld HERVIEUX, Versailles (FR); Gregory MEIGNAT, Versailles (FR)

(21) Appl. No.: 15/690,711

(22) Filed: Aug. 30, 2017

(30) Foreign Application Priority Data
Aug. 31, 2016 (EP) 16306100.5

(51) Int. Cl. F16J 9/12; F16J 15/00

(52) U.S. Cl. CPC F16J 9/12; F16J 15/002

(57) ABSTRACT

A sealing arrangement for an actuator, said sealing arrangement comprising: a sealing surface; and two or more seal recesses for receiving seals, said two or more seal recesses provided at the sealing surface of the sealing arrangement.

### FOREIGN PRIORITY

This application claims priority to European Patent Application No. 16306100.5 filed Aug. 31, 2016, the entire contents of which is incorporated herein by reference.

### TECHNICAL FIELD

The following relates to a seal arrangement for an actuator (e.g. rotary or linear actuator, or the like). Further, the following relates to an actuator assembly including a seal arrangement.

### BACKGROUND

Linear and rotary actuators are used in applications to move an external object when an unbalanced fluid pressure is applied to a piston. Dynamic sealing is used to ensure that pressurized fluid (e.g. air or hydraulic fluid) does not leak between the piston and other components of the linear and rotary actuators.

Dynamic sealing usually takes the form of a seal located around a piston head to ensure that fluid does not leak between the piston and other components. High Velocity Oxygen Fuel (HVOF) and other coatings are commonly used on the seal located around a piston head for corrosion and wear purposes.

### SUMMARY OF THE INVENTION

There is provided a sealing arrangement for an actuator, the sealing arrangement comprising a sealing surface and two or more seal recesses for receiving seals, the two or more seal recesses provided at the sealing surface of the sealing arrangement.

In an example, the two or more seal recesses comprise of at least a first seal recess and a second seal recess, said first seal recess and said second seal recess having a length in a longitudinal direction and a depth in an annular direction.

In a further example, the first seal recess is located at the sealing surface and wherein the length of the first seal recess is greater than the depth of the first seal recess.

In another example, the second seal recess is located adjacent the first seal recess and wherein the second seal recess is located at the sealing surface. The depth of the second seal recess is greater than the length of the second seal recess.

In an example, the second seal recess is located adjacent the first seal recess, wherein the second seal is located at the sealing surface, and wherein the length of the second seal recess is greater than the depth of the second seal recess.

In another example, the first seal recess is located at the sealing surface and wherein the depth of the first seal recess is greater than the length of the first seal recess.

In a further example, the second seal recess is located adjacent the first seal recess, wherein the second seal recess is located at the sealing surface, and wherein the depth of the second seal recess is greater than the length of the second seal recess.

In another example, the second seal recess is located adjacent the first seal recess and wherein the second seal recess is located at the sealing surface, and wherein the length of the second seal recess is greater than the depth of the second seal recess.

There is also provided an actuator assembly, comprising an actuator shaft, a first actuator portion of the actuator shaft, a second actuator portion of the actuator shaft, a first sealing arrangement assembled on the first actuator portion, a second sealing arrangement assembled on the second actuator portion, and wherein the first sealing arrangement and the second sealing arrangement (104) each comprise a sealing arrangement as described above.

In another example, there is provided a first inner wall in the first actuator portion and a second inner wall in the second actuator portion.

In a further example, there is provided a first chamber and a second chamber between the first inner wall and the actuator shaft, the first chamber being separated from the second chamber by the first sealing arrangement.

In another example, there is provided a third chamber and a fourth chamber between the second inner wall and the actuator shaft, the third chamber being separated from the fourth chamber by said second sealing arrangement.

In an example, the second chamber and third chamber are separated by a bearing.

In a further example, the first sealing arrangement and the second sealing arrangement are piston heads.

### BRIEF DESCRIPTION OF THE DRAWINGS

FIG. 1 shows an example of an actuator with a seal arrangement.

FIG. 2 shows an example of a seal arrangement.

### DETAILED DESCRIPTION

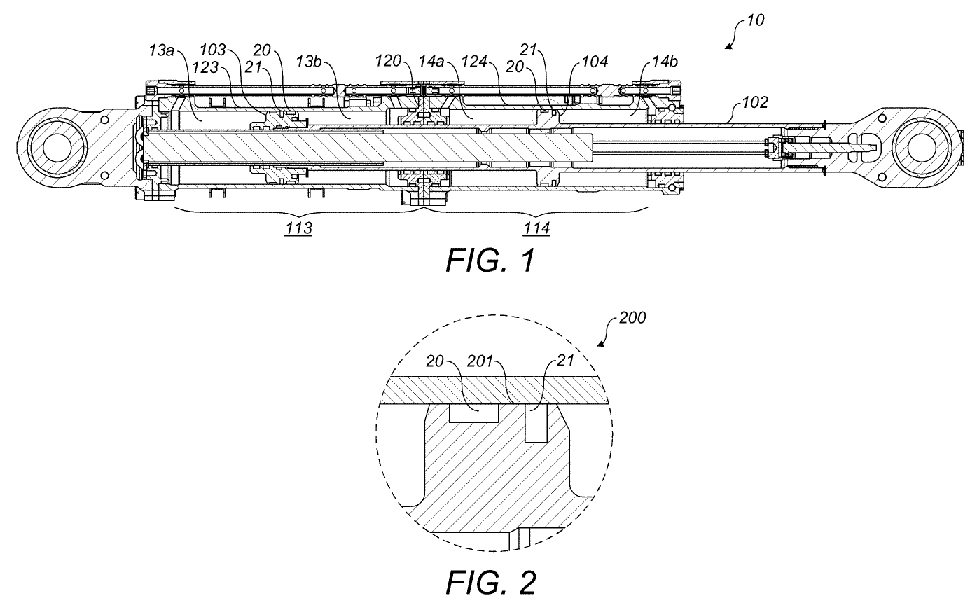

FIG. 1 shows an example of an actuator 10. The actuator 10 of the example shown in FIG. 1 is a dual cylinder actuator. It is to be understood however that the seal arrangements described below can be used with other actuators and are not limited to a dual cylinder actuator as shown in FIG. 1.

The actuator 10 may include an actuator shaft 102 extending longitudinally through the actuator 10. The actuator shaft 102 may include a first actuator portion 113 and a second actuator portion 114. Assembled on the first actuator portion 113 is a first sealing arrangement 103. Assembled on the second actuator portion 114 is a second sealing arrangement 104. The first sealing arrangement 103 and second sealing arrangement 104 extend circumferentially around the actuator shaft 102 in the respective first actuator portion 113 and second actuator portion 114.

As shown in FIG. 1, there may be provided a first inner wall 123 of the actuator 10 associated with the first actuator portion 113. Additionally, there may be provided a second inner wall 124 of the actuator 10 associated with the second actuator portion 114. The actuator 10 comprises a first chamber 13a provided between the first inner wall 123 and the actuator shaft 102. The actuator 10 also comprises a second chamber 13b provided between the first inner wall 123 and the actuator shaft 102. The first sealing arrangement 103 separates the first chamber 13a from the second chamber 13b. The actuator 10 may further comprise a third chamber 14a provided between the second inner wall 124 and the actuator shaft 102. The actuator 10 also comprises a fourth chamber 14b provided between the second inner wall 124 and the actuator shaft 102. The second sealing arrangement 104 separates the third chamber 14a from the fourth chamber 14b. In use, the first chamber 13a, second chamber 13b, third chamber 14a and/or fourth chamber 14b may be provided with fluid (e.g. gas or hydraulic fluid) such that the first actuator portion 113 and second actuator portion 114 may move the actuator shaft 102 when a pressure is provided against the first sealing arrangement 103 and/or second sealing arrangement 104. It is to be understood that the first sealing arrangement 103 and second sealing arrangement 104 are piston heads. The second chamber 13b and third chamber 14a are separated by at least one bearing 120.

The first sealing arrangement 103 and second sealing arrangement 104 provide a barrier to prevent fluid in the chambers 13a, 13b, 14a and 14b leaking into other components within the actuator 10. Leaking fluid to other components within the actuator 10 can cause catastrophic effects. The sealing arrangements shown in this example could also be coated with HVOF and other coatings. However, the HVOF coating and other coatings, and application thereof on actuators that do not include the sealing arrangements of the examples shown, are inefficient and can lead to further problems of leakage within linear and rotary actuators.

To alleviate failures, the linear actuator 10 of FIG. 1 includes sealing arrangements 103 and 104. An example of a sealing arrangement is shown in more detail in FIG. 2. The sealing arrangement 200 is an example of the sealing arrangements 103 and 104 shown in FIG. 1. The sealing arrangement 200 extends from an actuator to an inner wall of the actuator 10, an example of which is shown in FIG. 1. The sealing arrangement 200 includes a first seal recess 20 for receiving a first seal (not shown) and a second seal recess 21 for receiving a second seal (not shown). The first seal recess 20 and second seal recess 21 are located at a sealing surface 201 of the sealing arrangement 200, which in the example shown is the outermost surface of the sealing arrangement 200 (i.e., the outermost surface from the actuator shaft 102). In the example shown in FIG. 2, the first seal recess 20 and second seal recess 21 have a cross-sectional length and depth—the length is in a longitudinal direction and the depth is in an annular direction. In the example shown, the length of the first seal recess 20 is greater than the depth of the first seal recess 20. The first seal recess 20 is located at the sealing surface 201. The first seal recess 20 can therefore be said to be a ‘horizontal’ seal recess to receive for example a horizontal seal. The second seal recess 21 is also located at the sealing surface 201 of the sealing arrangement 200. In the example shown, the length of the second seal recess 21 is less than the depth of the second seal recess 21. The second seal recess can therefore be said to be a ‘vertical’ seal recess to receive for example a vertical seal. Of course, the example shown could also be modified such that there are two or more ‘horizontal’ seal recesses or two or more ‘vertical’ seal recesses, or two or more ‘horizontal’/‘vertical’ seal recesses in any combination. In an example, the horizontal seal could be a Trelleborg Turcon plus seal II® and the vertical seal could be a Trelleborg® dual piston ring. In the example shown, the seals prevent leakage of fluid into components of an actuator. The use of two seals within the seal recesses provides a low probability that both seals will wear down simultaneously—therefore, improving the safety of a system.

Referring back to FIG. 1, it can be seen in this example that the first sealing arrangement 103 includes a ‘horizontal’ seal recess 20 on a rightmost portion of an outermost surface and a ‘vertical’ seal recess 21 on a leftmost portion of the outermost surface of the first sealing arrangement 103. The second sealing arrangement 104 includes a ‘horizontal’ seal recess 20 on a leftmost portion of an outermost surface and a ‘vertical’ seal recess 21 on a rightmost portion of the outermost surface. Therefore, the seal recesses are arranged in the second sealing arrangement 104 to be ‘inverted’ to the seal recesses of the first sealing arrangement 103. Of course, the seal recesses of the first sealing arrangement 103 and second sealing arrangement 104 may not be ‘inverted’ in their positioning and may include a combination of two or more ‘horizontal’ and ‘vertical’ seal recesses. The additional seals provided within seal recesses in the piston arrangement allow for a safer system in that, if there is a hidden failure and one seal breaks, there is a very low probability that the remaining seals will also break. Therefore, this provides a failsafe mechanism and avoids hidden failures which may lead leaking fluid that cause catastrophic events to the actuator system.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A sealing arrangement for an actuator, said sealing arrangement comprising:
a sealing surface; and
two or more seal recesses for receiving seals, said two or more seal recesses provided at the sealing surface of the sealing arrangement.

2. The sealing arrangement of claim 1, wherein the two or more seal recesses comprise of at least a first seal recess and a second seal recess, said first seal recess and said second seal recess having a length in a longitudinal direction and a depth in an annular direction.

3. The sealing arrangement of claim 2, wherein the first seal recess is located at the sealing surface and wherein the length of the first seal recess is greater than the depth of the first seal recess.

4. The sealing arrangement of claim 3, wherein the second seal recess is located adjacent the first seal recess and wherein the second seal recess is located at the sealing surface and wherein the depth of the second seal recess is greater than the length of the second seal recess.

5. The sealing arrangement of claim 3, wherein the second seal recess is located adjacent the first seal recess, wherein the second seal is located at the sealing surface, and wherein the length of the second seal recess is greater than the depth of the second seal recess.

6. The sealing arrangement of claim 2, wherein the first seal recess is located at the sealing surface and wherein the depth of the first seal recess is greater than the length of the first seal recess.

7. The sealing arrangement of claim 6, wherein the second seal recess is located adjacent the first seal recess, wherein the second seal recess is located at the sealing surface, and wherein the depth of the second seal recess is greater than the length of the second seal recess.

8. The sealing arrangement of claim 6, wherein the second seal recess is located adjacent the first seal recess and wherein the second seal recess is located at the sealing surface, and wherein the length of the second seal recess is greater than the depth of the second seal recess.

9. An actuator assembly, comprising:
an actuator shaft;
a first actuator portion of the actuator shaft;
a second actuator portion of the actuator shaft;
a first sealing arrangement assembled on the first actuator portion;
a second sealing arrangement assembled on the second actuator portion; and
wherein said first sealing arrangement and said second sealing arrangement each comprise a sealing arrangement that includes:
a sealing surface; and
two or more seal recesses for receiving seals, said two or more seal recesses provided at the sealing surface of the sealing arrangement.

10. The actuator assembly of claim 9, wherein there is provided a first inner wall in the first actuator portion and a second inner wall in the second actuator portion.

11. The actuator assembly of claim 10 wherein there is provided a first chamber and a second chamber between the first inner wall and the actuator shaft, said first chamber being separated from said second chamber by said first sealing arrangement.

12. The actuator assembly of claim 10, wherein there is provided a third chamber and a fourth chamber between the second inner wall and the actuator shaft, said third chamber being separated from said fourth chamber by said second sealing arrangement.

13. The actuator assembly of claim 12, wherein the second chamber and third chamber are separated by a bearing.

14. The actuator assembly of claim 9, wherein the first sealing arrangement and the second sealing arrangement are piston heads.

15. The actuator assembly of claim 10, wherein the first sealing arrangement and the second sealing arrangement are piston heads.

16. The actuator assembly of claim 11, wherein the first sealing arrangement and the second sealing arrangement are piston heads.

17. The actuator assembly of claim 12, wherein the first sealing arrangement and the second sealing arrangement are piston heads.

18. The actuator assembly of claim 13, wherein the first sealing arrangement and the second sealing arrangement are piston heads.
